(19) United States
(12) Patent Application Publication
(10) Pub. No.: US 2002/0169676 A1
(43) Pub. Date: Nov. 14, 2002

(54) Shop by brands internet (online) portal

(76) Inventor: Mary Lou Floyd, Union City, NJ (US)

Correspondence Address: MARY LOU FLOYD, 380 MOUNTAIN RD, #1212, UNION CITY, NJ, 07087, US

(21) Appl. No.: 09/681,629

(22) Filed: May 13, 2001

(51) Int. Cl. G06F 17/60

(52) U.S. Cl. 705/26

(57) ABSTRACT

Searching for and finding information on the Internet is not new and searching for and finding brand products isn't either. Searching for business URL addresses with the expectation of receiving a correct URL clearly displayed by itself without any other related and supportive information is new. An online consumer reaching a brand name site in fewer clicks with a greatly shortened list of search returns would differentiate from the current lengthy online experience. This is the experience this invention is hoping to replace.

### BACKGROUND OF INVENTION

This patent proposal is in the field of Internet applications. (U.S. Patent Classification Definitions were checked. While the Data Processing selections came closest, they did not seem entirely applicable to this invention.) Specifically, it offers a new, more satisfying and successful way for online customers to begin their shopping and buying experience on the web and for brand marketing companies to reach and satisfy those customers there.

Recent internet audience research (Forrester Research's technographics studies and American Express Global Internet Survey, 2000) confirms that online consumers prefer to buy direct from brand names where they feel they will get the best price and the most complete range of products. Research also shows that most consumers begin their internet shopping by seeking their favorite brand names via search engines that are not found to deliver a clean, concise, accurate or uncluttered search list.

There are numerous URLs that have the word “brand” in the name, i.e. brandwise.com, brandmall.com, etc. There are a number of web sites where you will find brand name merchandise. None of these alternatives accommodate all the brand names or even 50% of them—in a particular product category. In most cases a brand name appears only if that company has struck a marketing deal with the search engine or commerce web site. More research indicates that 56% of catalogue searches on business to consumer online retail sites fail—and 93% on business to business e-commerce sites—because these searches usually turn up extraneous results that are too lengthy and tedious to sort through. Therefore, consumers need an easy way to be reminded of and to find brand name web sites for their online shopping pleasure. Consumers need www.shopbybrands.com. With this internet/web application, customers don't have to know or guess at a brand company's URL until they get it right. They also don't need to hunt through the numerous listings returned by a search engine that may or just as likely may not include the correct URL. Also, with this application, brand companies don't have to register and buy multiple URLs to ensure their customers can find them on the web; be concerned with customers misspelling their company name or not remembering it altogether and pay competitive prices to buy URLs with their company name that could be owned by someone else. This brand and product search engine would eliminate all these problems because customers wouldn't have to make more than one attempt to find a brand web site and brand companies wouldn't have to spend as much money as they do today purchasing multiple URLs and expensive drive to web campaigns.

### SUMMARY OF INVENTION

This is a request for a patent for a unique Internet search engine and marketing model. Specifically, a customer accesses or is delivered a web page with her computer or other online devise. She either types or inputs in some way onto that web page 1) a brand name and 2) a product category (optional) and is returned a page with a company's URL address and link to the actual brand site. In its most basic terms this web application is an exclusive but all inclusive search engine for the top infinite number of brand name companies. It can also be thought of as a brand cybermall where customers can find the brand company they want to shop and be navigated to their front door. It is not an online transactional commerce site itself, but rather it delivers shoppers to the brand name commerce site where the actual purchase would transpire.

### DETAILED DESCRIPTION

The primary objective of this invention is to inform the end-user of a brand company's URL, although other compelling value added benefits will be explored and offered later on after the initial introduction of the service. This is a request for a patent for a unique Internet search engine and marketing model. Specifically, a customer accesses or is delivered a web page with her computer or other online devise. She either types or inputs in some way onto that web page 1) a brand name and 2) a product category (optional) and is returned a page with a company's URL address and link to the actual brand site. In essence this returned page acts like a jump page to the company's homepage. In its most basic terms this web application is an exclusive but all inclusive search engine for all the top infinite number of brand name companies. It can also be thought of as a brand cybermall where customers can find the brand company they want to shop and be navigated to their front door. It is not an online transactional commerce site itself, but rather it delivers shoppers to the brand name commerce site where the actual purchase would transpire.

Consumers can also enter a product category by itself in return for a list of brand names and URLs that offer that particular product line, Regardless of the business models outlined below, it's important that all the most well known brands in each category be searchable. One of the unique advantages of this concept is that consumers should feel that they can find any brand's URL and that their search not be dependent on advertising or sales arrangements.

Other useful company information can also be served with the URL on a jump page or an “Enhanced URL Page.” This page presents more frequently requested basic information—special promotions, store locations, store hours, phone numbers, current sales, etc.—the types of things consumers would normally want to know right away when in a shopping mode. More research will be conducted to better define these needs so as to better advise brand companies who choose to take advantage of this added feature.

What is being proposed here is a simple yet new and unique alternate approach to initiate online shopping for consumers and consumer brand companies. (This concept is easily expanded to a business to business commerce scenario as well.) While there are numerous web sites that provide e-commerce with a focus on brands, none of them have been designed or developed in a manner that more intuitively reflects and duplicates how a customer generally prefers to shop, i.e., starting with brand names they know and trust.

This service is named “Shop By Brands” and can be accessed at www.shopbybrands.com. (The inventor currently owns this URL.) Depending on the business model, consumers could be served the site from a sponsor's web presence as well. As an added convenience for frequent web shoppers, it can also be reached by installing an icon right onto the consumer's desktop.

This innovative proposal translates this preferred brand shopping experience to the Internet and starts to deliver what some of the basic research is telling us online audiences want. It's based on two premises: 1) Technographics research shows that consumers begin their internet shopping trips at search engine sites, where they seek out a particular brand or product. This is the first step in building an experiental brand for the end-user. So the company's web site or URL better appear and without any other competing, compromising or distracting data if this brand experience is to be initiated on a positive note. However, returned search lists are long and delivered with other extraneous information that take the user time to read through to find what they want.

The presence of popular and familiar brand names are instrumental in increasing the selling power of the internet. Consumers in general have established a certain comfort level with these companies that cannot afford to be adversely effected with their online experience. The brand's attributes must be reflected from the moment the user thinks of the name, enters it in a search box and reviews the returned search page. Brand companies can't control this task and because a consumer's initial online experience is critical to sustaining their comfort level with the brand, successful and positive brand impressions are repeatedly and totally abandoned on the web every day as a result.

What if a consumer can't think of the brand name when beginning their search? If the brand hasn't partnered with that portal/search engine, your customer will be delivered a list of competitors. In both cases brand companies can lose their customers before they've even arrived at their site.

2) Consumers expect manufacturing brands to sell direct over the Internet even if they've never sold direct before. They assume brand sites are the best place to shop for and purchase products at the lowest price. This is because supply & demand is more instantaneous and therefore becomes more apparent on the web, the premise for such sites as Mercata, DealTime, mySimon and Bottomdollar. Prices fall naturally to the lowest competitive point and vary more as demand shifts.

This concept of Dynamic Trade offers greater benefits to direct sellers than indirect ones on the Internet. The direct sellers who build their online business around intangible assets, such as customer base and technology infrastructure, will reap the greatest rewards. This is the key to creating economies of scale. As a result physical distributors will be more important to brand manufacturers as sales through retail stores are replaced in part by direct sales over the Internet. Because consumers look for the products first at foremost brand sites, most manufacturers are hosting their own consumers in search of products. Another reason consumers prefer to buy directly from a brand name company is because they are also attracted to web sites that offer a complete range of products. Retail web sites and online malls who must achieve a certain scale in order to be competitive, such as brandwise.com and buy.com, sell brand products but normally never a brand's entire product line. Brand companies wanting to increase their reach on the internet can negotiate a deal with one of these shopping web sites or malls whereby specific brand products are made available on the reseller's site but again never the complete inventory. In addition retail sites do not usually display the brand's image satisfactorily, compromising comfort levels as alluded to above. So if consumers look for products first at brand sites, why make them go somewhere else to buy? There are numerous working URLs that have the word “brand” in the name. There are also a number of web sites that aim to provide a shopping experience where you will find brand name merchants and merchandise. However, no other online commerce site delivers the capability of finding actual brand companies' own web sites quickly and easily within an e-commerce environment. ShopByBrands is not a commerce engine, which means transactions are not performed on the site unlike most of these other online malls. Also, the sites referenced below only offer a specific number of brand names and a finite range of their products in limited product categories. Some of these dot.coms are: Brandwise is a comparison-shopping web site that offers consumers home products only, i. e., washing machines, dryers, refrigerators, microwaves, dishwashers, cooking units, TVs, DVD players and camcorders on www.brandwise.com. There are plans to include other product categories including lawn and garden, small appliances, baby products, etc. (Web site currently under transition.) Brandsmall is an internet retailer of brand name consumer products, i.e., consumer electronics, home and garden, home office, health and beauty, jewelry, gifts and more. They provide simple product search tools, many product suggestions and clearance and sale sections. They also provide customer service representatives and a 30-day return policy.

Price Watch is advertised as “the fastest way to find a great street price on a computer product.” A user can use the ‘search’ box or click through category or manufacturer lists. Dealers advertise and maintain their prices on Price Watch using their proprietary systems. At this time, there is a limited product category site.

Priceline has pioneered a unique new type of e-commerce with which most everyone is familiar. Consumers can use the Internet to save money on a wide range of products and services by bidding on the items. This “name your price” approach also enables sellers to generate incremental revenue. Consumer demand (in the form of individual customer offers guaranteed by a credit card) is collected for a particular product or service at a price set by the customer and communicated directly to participating sellers or to their private databases. Consumers agree to hold their offers open for a specified period of time to enable priceline.com to fulfill their offers from inventory provided by participating sellers. Once fulfilled, offers generally cannot be canceled. By requiring consumers to be flexible with respect to brands, sellers and/or product features, sellers are enabled to generate incremental revenue without disrupting their existing distribution channels or retail pricing structures. In this model, clearly brand is of the least importance.

Buy.com offers the latest computer hardware and software, the newest releases of videos and DVDs, the hottest console and PC games, chart-topping music CDs and the top selling books all at guaranteed everyday low prices. A sister site, BuyClearance.com, sells closeout items at greater savings. Shoppers can purchase computers from BuyComp.com and add their favorite CD from BuyMusic.com with all their purchases combined into one easy checkout basket. The product categories are limited to the ones stated above for the present.

Mercata's premise is simple: pool the purchasing power of buyers who have a common goal of buying and receiving a discount on goods and services. Then, connect those buyers with the sellers of those products and services. Each buyer can generally benefit by achieving a lower price than would have been possible for an individual, and sellers can benefit by engaging in one large, low-cost transaction. In short, it's often a win-win for both buyers and sellers because individual buyers are able to combine their purchasing power to receive volume pricing benefits on featured merchandise. Product categories include appliances, baby products, electronics, giftsand gadgets, home and kitchen items, lawn and garden products, luggage, sporting goods, tools, and watches and jewelry. While visitors can browse and shop by consumer brands, the list of names is limited and the emphasis is on price not brand. (Now defunct) InternetMall, a comparison shopping network, is a part of the Network Commerce Consumer Network (NCCN) featuring over 900,000 businesses and merchants in over 230 countries. It consists of ShopNow.com (http://www.shopnow.com), a leading shopping network and directory featuring over 60,000 merchants; SpeedyClick.com (http://www.speedyclick.com), a leading commerce-enabled entertainment community; and over 35,000 affiliate sites. NCCN is primarily a leading provider of technology infrastructure, services and networks for businesses, merchants, Internet sites, and wireless networks conducting commerce online. Dealtime is a free online comparison shopping service that is intended to save the consumer time and money shopping on the Internet. DealTime searches across the web for sites offering the best deals on products. It's not an online store itself but rather a site that lists deals from online stores, auctions and buying groups that match the buyer's criteria. Their goal is to help the end-user reduce their comparative shopping from days to a few minutes. The product categories are limited at this stage and again the emphasis is on price not brand.

Storerunner was one of the first online shopping sites on the Web to offer a wide selection of products and services from the most trusted retailers, with technologies enabling users to shop online or in their own neighborhoods. Their expanded database contains over one million products in over 8,000 different categories. StoreRunner has embedded its cutting-edge shopping technologies, rich content, and flexible interface into a continually expanding network of high-traffic web enterprises including Verizon, Juno Online Services, DoubleClick and FreeLotto. Through this network, StoreRunner helps destination and portal sites increase their site traffic and enhance their online communities, while placing the products and services of StoreRunner's merchants within reach of millions of online shoppers. Here retailers are searched not brands.

MySimon helps consumers shop for millions of products at thousands of online stores. It's not an online store; they don't sell anything. It's not a generic search engine either; they don't simply list the names of every store on the Web. Rather they offer an unbiased service that helps shoppers decide what to buy and where to buy it. They do this by a team of helpers built with patent-pending software. The Virtual Learning Agent™ technology creates “intelligent agents” trained by a team of shopping experts to collect information from any online store NOT brand sites. Merchants aren't required to pay to be a part of the service. However, a few places around the pages are offered for advertisers with several ways to deliver their message. Their goal is to win shopper's respect as the place to start shopping online, no matter what the product. They not only compare prices but also show product availability, shipping specifications, and other useful information where possible.

ShopForBrands attempts to provide shoppers a one stop shopping place for viewing and buying good quality products and services at extremely reasonable prices from reputed merchants. By providing multiple links, they encourage shoppers to spend a little time and visit different sites, compare prices and features to find the online merchant offering the most reasonable price. Their goals are to be able to generate revenues from this shopping portal (when you buy something through the merchants listed on ShopForBrands, those merchants pass on a commission back to ShopForBrands) to donate to those charities, which provide support to children.

The steps to create this service are just as simple as the service itself:* Recruit executive management, marketing, commerce, business development and technical development skills* Research to learn more about how mainstream consumers and online laggards want to use the internet to shop.

Research and create a list of the top (number to be determined) brands name companies and their product categories.

Evolve and sell the marketing model.

Design and program the search engine.

Develop a directory ad campaign and solicit brand name companies.

Develop a consumer ad campaign.

Design www.shopbybrands.com web site* Develop prototype site to use to sell concept to advertisers and consumers. Several different business models and separate category of investors can be considered for www.shopbybrands.com because its easy ability to create an online community is advantageous to a number of players in the Internet space. These multiple possibilities can also complement each other and be combined in various fashions. One can be the exit strategy for the other. Below is an overview of the potential models and investors: VC Funded This proposal can be backed in the traditional dot.com manner by securing funds from one or several venture capital investment firms. While this type of funding may be more difficult to find due to the recent failures of a number of well-known dot.coms, some VC funders will see this business proposition's uniqueness. They'll see it as a realistic way to engage large communities of users in a more gratifying experience.

This type of funding is based on showing a profit (ROI) within a specific timeframe. In this event ShopByBrands can create revenue in two ways: brand advertising on the site and a percentage share (one to five percent) of each e-commerce transaction on a brand's site tracked back to www.shopbybrand.com. The financials have not been forecasted in this early proposal although these two revenue streams have proved positive on paper and in execution many times before. Any advertising revenue stream will need to be more inventive than the usual banner advertising, which continues to wane as a results-driven online advertising choice for brand marketers.

A unique advertising model that could prove very successful has similarities to directory advertising. Every brand gets a simple web page with their URL on it as described above. They can also elect to provide content for the “Enhanced URL Page,” a ShopByBrands template page that delivers other pertinent shopping information, such as store locations and departments, special events and store promotions. While there will be no initial fee for providing this additional information, later releases will offer features for brands to take advantage of via a rate card.

Established search engines could be viewed as competitors who could easily mimic this business model. However they would have to do so at the risk of alienating the online malls who are major advertisers and partners on their sites. This overall concept does not ultimately work to their advantage and in fact impacts these cybermalls in quite the opposite fashion because is promotes shopping at brand sites not cybermalls or reseller sites. It's the brand sites that can elect to link their consumers to these retail sites as part of their sales channels. This would necessitate a different pricing structure to be negotiated between these sites and the brands not www.shopbybrands.com.

Internet Portal, Online RetailSite, ISP or ASP Owned

An Internet portal or search engine, such as Yahoo or Alta Vista, are already the beginning sites for a good majority of consumer shopping experiences. Any of these would also be logical candidates for this proposal. As previously stated, these established URL's could also present potential competition to this concept in that they could find a way to easily replicate it. They could avoid any conflict with online mall sites that are their advertisers if this innovation did not come from a third-party representative. For that matter the online malls that offer a vast range of brand products would also be an ideal funder or takeover initiator as they're already identified as a place to shop for brands.

ISPs like AT&T Worldnet or MSN are obvious choices to own this concept as well. They are also already the initial starting place for millions of Internet users.

ShopByBrands helps keep their customers on their pages, which makes them stronger destination sites on the Internet.

Marketing Company Sponsored

This proposal also presents a unique opportunity for a large business to business corporation that normally spends a huge amount of its marketing budget appealing to other large brand name companies. Their goal would not have to be to make a profit as this would not be a product line for them. Rather it could complement a service they are already selling as a value added feature. For example, a company that sells web-hosting services to a brand name company could also offer special positioning for their largest customers on www.shopbybrands.com as an additional selling point. While all brands need to be included in the brand database, a corporation could feature their more profitable brand clients in a special way.

Reviewing a list of corporations whose product line is targeted at most if not all major brand name companies would be a likely place to begin identifying possible candidates. Entertainment and telecommunications companies are some of the more logical opportunities. The television industry relies heavily on brand name commercial sponsorship. Telephone companies already publish directories, offline and online, that deliver company names as a result of a search effort on the part of a customer. Their advertisers could be offered premier listing on www.shopbybrands.com or a hot link similar to directory advertising. Directory advertising has different tiers....a regular listing, a bolded listing, a featured box, etc. These tiers could be based on the amount of revenue generated from their customer accounts.

Other hardware, software and services companies that are particularly known for their reputation in the internet space, such as IBM, Microsoft and Federal Express would also benefit from owning such a consumer web experience. It enhances their own identity on the web and creates a practical reason for users to come to their site thereby increasing their own traffic and marketing possibilities. They can offer their own brand name customers special treatment on this brand-focused site. As the traffic to www.shopbybrands.com grows, the site becomes quite valuable in terms of delivering audience numbers.

The marketing corporation could also buy this concept and/or site from its originators or a VC firm and run it for themselves. This online presence could be incorporated with their corporate web site and with an already existing legacy database of the company's customers.

The beginning link to www.shopbybrands.com could be positioned on the marketing company's own homepage. The success of such a useful tool would attract consumers to the marketer's site more frequently presenting the opportunity for them to build their brand image and increase their traffic on the marketing company's own corporate site. This is important as getting consumers to your website needs to be innovated again and again in many amazing and original ways. This is an answer to every corporation's current challenge how to reinvent themselves on the Internet? ebusiness Consulting Company Supported Other types of companies that could benefit from owning this concept and engine are consulting and strategic planning companies like an Oxford or Anderson. Also interactive advertising agencies and backend software development companies that have both redefined themselves as e-business strategy companies, such as a Sapient or a Modem Media, should also be considered. The Internet is the apex of an e-business. These service companies are retained by brand name clients to help them move their operations and commerce to the web. Hosting links to brand name sites, some of which these consulting companies help built, is a credible way to prove their e-commerce and e-business expertise. They would value being known as the web site to go to begin an online commerce event. It would increase their visibilty in the business marketplace.

These companies also have natural brand expertise because of what they've gained from their traditional consulting work. They understand how all well know brand companies operate who are their primary bread and butter clients. Underwriting ShopByBrands and offering it to their clients as a value add helps to support their sales premise and corporate mission.

Because anyone of these models could be successful, one can represent a way for the group creating and managing the business to be initially funded while another can be a means for the incubators to exit increasing the financial options and fallback strategies.

1. What I claim as my invention is the ability to search for brand name companies' URL addresses exclusively within the Internet and interactive television environments. In other words, the users expectation of finding a specific company's URL in one or two clicks without the need to read a list of returned options can be realized. The URL is found by either inputting what is or is thought to be the correct spelling of a company's name and/or a specific product line. The only URLs returned to the user are those of the brand name company or companies in the case of a product line search. Links to sites other than the brand company site being searched (i.e., a publishing or media web site like msnbc.com or time.com) with information about that company or similar companies is not a part of this claim.

2. This patent should cover any online application that promises to deliver company URL addresses as the first and primary piece of information that is returned to a search user. The user's goal and expectation are ultimately to get to a brand name company's homepage or a substitute portal or jump page as determined by the brand name company swiftly and in a seamless manner as possible.
